(19) United States
(12) Patent Application Publication
(10) Pub. No.: US 2008/0189940 A1
(43) Pub. Date: Aug. 14, 2008

(54) Communication cable with an asymmetrically clad steel shield

(75) Inventor: James S. Tyler, Woodstock, GA (US)

Correspondence Address: KING & SPALDING LLP, 1180 PEACHTREE STREET, ATLANTA, GA, 30309-3521, US

(73) Assignee: Superior Essex Communications LP, Atlanta, GA (US)

(21) Appl. No.: 11/706,793

(22) Filed: Feb. 14, 2007

(51) Int. Cl. H01B 7/00

(52) U.S. Cl. 29/828; 174/36; 29/825

(57) ABSTRACT

A data communication cable can comprise multiple pairs of twisted conductors within an outer jacket. A shielding can be disposed between the conductors and the outer jacket. The shielding may be an asymmetrically clad alloy steel (ACAS) tape wherein the copper cladding of the shield is thicker on a first side and thinner on a second side. When the tape is positioned between the conductors and the jacket, the thicker copper layer can be positioned adjacent to the conductors. The thicker copper layer can reduce the capacitive coupling between the conductors and the steel layer of the shielding tape without the added expense of an inner jacket or increased insulation thickness between the conductors and the shielding tape. The tape may also reduce lightning noise and other electromagnetic interference. Additionally, copper layers of the tape can help prevent corrosion of the inner steel layer.

### FIELD OF THE INVENTION

The present invention relates to communication cables with shielded twisted pair conductors and more specifically to the use of a asymmetrically copper clad tape with an alloy steel inner layer as the shield of the cable.

### BACKGROUND

Buried cables for non-gopher resistant applications traditionally utilize a bronze shield. The bronze is historically alloy C220 and contains approximately 90% copper. The shield is the predominate contributor to the cost of the buried cable. As the cost of copper rises, the cost of such buried cables also increases.

Another type of buried cable instead has a shielding of copper clad steel (CCS). This CCS shielded cable is typically used in applications requiring gopher resistance. The CCS tapes contain less copper than the bronze shields and are, therefore, less expensive. These CCS tapes are also known as bimetallic tapes or bimetallic shields.

The bronze shields and the CCS shields are useful for providing gopher resistance as well as for protection from lightning surges and electromagnetic interference.

CCS bimetallic shields utilize a construction of two copper layers on either side of an inner steel layer. Traditionally, the two copper layers are of equal thickness. Capacitive coupling between the conductors in the core of the cable and the steel layer of the bimetallic shield can be problematic. This capacitive coupling increases the mutual capacitance between the conductors as well as signal attenuation along the conductors. Generally, gopher resistant cables have an inner jacket separating the conductors in the core of the cable from the bimetallic shielding. This inner jacket provides a spacing between the conductors and the shielding. This spacing decreases the capacitive coupling between the conductors and the shield and also decreases the negative effects associated with the capacitive coupling.

However, non-gopher resistant cables do not generally require an inner jacket. Thus, the use of a bimetallic CCS shielding for non-gopher resistant applications (such as cost reduction of the shielding) can involve a cable with a CCS bimetallic shielding and no inner jacket. In such a cable, the bimetallic shield is much closer to the conductors. The proximity of the steel layer within the CCS shielding to the conductors can increase the capacitive coupling to unacceptable levels. This can be mitigated by various means, such as utilizing an inner jacket or significantly increasing the insulation thickness over the conductors. However, these approaches add substantially to the cost of the cable.

Accordingly, there is a need in the art for a buried cable with a bimetallic CCS shield that does not suffer from excessive capacitive coupling between the shield and the conductors when the conductors are positioned adjacent to the bimetallic shield.

### SUMMARY

The present invention supports a buried cable comprising a bimetallic shield (also called a bimetallic tape) where the thickness of the copper is increased on one side of the tape and decreased on the other side of the tape. Such a tape can be referred to as asymmetrically clad alloy steel (ACAS) tape. The side of the tape having the thicker copper can be placed adjacent to the conductors of the cable. The thicker copper between the steel layer of the shield and the conductors can act to substantially reduce the capacitive coupling.

In one aspect of the ACAS shielding, the reduced capacitive coupling can enhance the performance of the cable with respect to mutual capacitance and attenuation without resorting to the use of an inner jacket or significantly increasing the conductor insulation diameter.

Another aspect of the ACAS shielding is that overall protection from lightning surges and electromagnetic interference is maintained. Additionally, the thin layer of copper on the outside of the shield protects the inner layer of steel from corrosion. These beneficial aspects are realized while achieving the cost benefits of reducing the total amount of copper in the shield.

The discussion of asymmetrically clad alloy steel tapes for use as shielding in buried communication cables presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIG. 1 illustrates a cross-sectional view of an asymmetrically clad alloy steel tape according to one exemplary embodiment of the present invention.

FIG. 2 illustrates a cross-sectional view of a communication cable with an ACAS shielding tape according to one exemplary embodiment of the present invention.

FIG. 3 is a chart comparing physical properties of ACAS shielding tape with the physical properties of bronze shielding tape according to one exemplary embodiment of the present invention.

FIG. 4 is a chart comparing physical properties of cables with ACAS shields and cables with bronze shields according to one exemplary embodiment of the present invention.

FIG. 5 is a logical flow diagram of a process for manufacturing a cable with an asymmetrically clad alloy steel tape according to one exemplary embodiment of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention supports a cable used to communicate, voice, data or other information. The cable can comprise multiple pairs of twisted conductors and an outer jacket that extends along the outside surface of the cable defining a longitudinal core, internal to the cable. The conductor pairs can be disposed in the core of the cable along with a shielding tape. The shielding tape can be positioned around the conductors but within the outer jacket.

The shielding may be an asymmetrically clad alloy steel (ACAS) tape. The asymmetrical cladding comprises copper that is thicker on a first side of the tape and thinner on a second side. When the tape is positioned between the conductors and the jacket, the thicker copper layer can be positioned adjacent to the conductors. The thicker copper layer can reduce the capacitive coupling between the conductors and the steel layer of the shielding tape without the added expense of an inner jacket or increased insulation thickness between the conductors and the shielding tape. The tape may also reduce lightning noise and other electromagnetic interference. Additionally, the copper layers of the tape can help prevent corrosion of the steel layer.

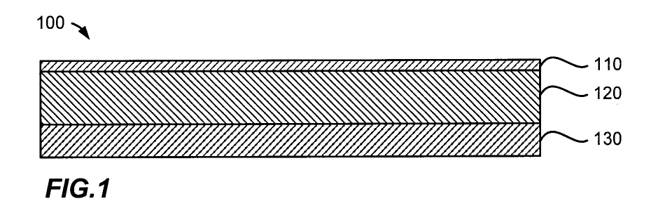

Exemplary cables comprising an ACAS shielding tape will now be described more fully hereinafter with reference to FIGS. 1-5, which describe representative embodiments of the present invention.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

Turning now to FIG. 1, this figure illustrates a cross-sectional view of an asymmetrically clad alloy steel tape 100 according to one exemplary embodiment of the present invention. An inner layer of steel alloy 120 is positioned between a thinner copper layer 110 and a thicker copper layer 130. The copper can placed onto the steel by deposition, electroplating, or various other mechanisms known in the art. For example, separate layers of steel and copper can be rolled together. The use of steel on the inner layer 120 of the tape 100 and copper on the outer layers 110, 130 of the tape 100 is exemplary and not intended to be limiting. That is, other metals or alloys may be used. For example, the two outside layers 110, 130 may be an alloy of copper or other metal having a high conductivity such as aluminum for example. The inner layer 120 of the tape 100 may generally be a ferromagnetic metal, alloy, or material.

One exemplary dimensioning of the bimetallic ACAS tape 100 can comprise an overall thickness of 3.75 mils with a layering ratio (by volume) of 5% copper, 55% steel, and 40% copper. This example would result in the three layers having thicknesses of 0.19 mils of copper, 2.06 mils of steel and 1.5 mils of copper. Another exemplary embodiment may have layers of 0.2 mils of copper, 2 mils of steel, and 1.5 mils of copper. These are mere examples and are not intended to limit the invention. Various other thickness ratios can be employed where a layer of steel is positioned between two copper layers and one of the copper layers is thicker than the other copper layer. These other thickness ratios do not depart from the spirit or scope of the invention.

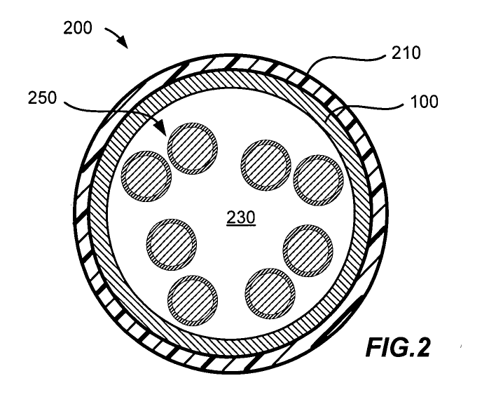

Turning now to FIG. 2, this figure illustrates a cross-section of a communication cable 200 with an ACAS shielding tape 100 according to one exemplary embodiment of the present invention. An outer jacket 210 can define the exterior of the cable 200 as well as the interior core 230 of the cable 200. Insulated conductors 250 can be positioned within the core 230 of the cable 200. An asymmetrically clad alloy steel tape 100 can be positioned around the conductors 250 within the core 230 of the cable 200. The asymmetrically clad alloy steel tape 100 can be positioned within the outer jacket 210 of the cable 200.

The outer jacket 210 can seal the cable 200 from the environment and provide strength and structural support. The outer jacket 210 can be characterized as an outer sheath, a jacket, a casing, or a shell. The outer jacket 210 can be extruded or pultruded and can be formed of plastic, rubber, PVC, polymer, polyolefin, polyethylene, modified ethylene-CTFE (under the trademark VATAR), acrylic, polyamide (nylon), silicone, urethane, or other insulator, for example.

The core 230 of the cable 200 can contain air, a gas, paper, a filler, a cross filler, an asymmetrical cross filler, a foam filler matrix, or any other filler material. The cable 200 may be either an air-core design or the cable 200 may contain water-blocking material. An inner jacket may also be positioned within the core 230 of the cable 200

The insulated conductors 250 can be copper, aluminum, gold, silver, an alloy, or any other conductive material covered by an insulator formed of plastic, paper, rubber, PVC, polymer, polyolefin, polyethylene, polypropylene, flouropolymer, modified ethylene-CTFE (under the trademark VATAR), acrylic, silicone, urethane, or any other insulating material, for example. The insulation of the conductors 250 may be solid, or cellular, or a combination thereof, for examples.

The conductors 250 can be grouped in sets of two as twisted pairs. Alternatively, the conductors 250 can be ungrouped or grouped in sets of three, four, five, six, seven, eight, or more than eight conductors, for example. Also, there can be one, two, there, four, five, six, seven, eight, 16, 48, 50, 100, or any other number of total conductors 250 within the cable 200. One or more of the conductors 250 can also be optical fibers. One or more of the conductors 250 can also be coaxial assemblies.

Referring now to both FIG. 1 and FIG. 2, the bimetallic ACAS tape 100 can be positioned around the conductors 250 of the cable 200 so that the thicker layer of copper 130 is adjacent to the conductors 250. In other words, the thinner layer of copper 110 can be adjacent to the outer jacket 210 of the cable 200. The thicker layer of copper 130 can form a shield between the steel layer 120 of the ACAS tape 100 and the conductors 250. This shielding effect can reduce the capacitive coupling between the ACAS tape 100 and the conductors 250. The shielding effect can also reduce general electromagnetic coupling between the ACAS tape 100 and the conductors 250. The bimetallic ACAS tape 100 can be positioned around the conductors 250 in a longitudinal or helical geometry.

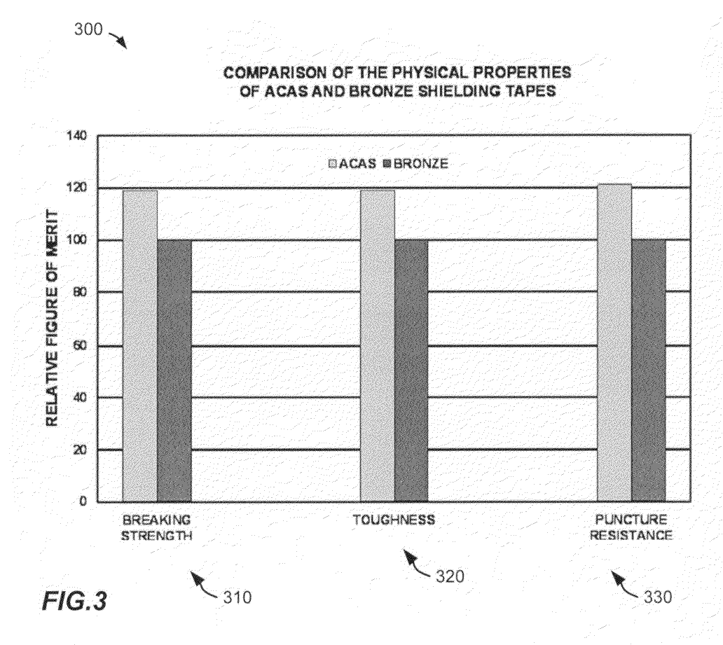

Turning now to FIG. 3, this figure is a chart 300 comparing physical properties of ACAS shielding tape with bronze shielding tape according to one exemplary embodiment of the present invention. The chart 300 shows the relative figures of merit for breaking strength 310 to be 100 for the bronze shielding tape and 120 for the ACAS shielding tape. The chart 300 shows the relative figures of merit for toughness 320 to be 100 for the bronze shielding tape and 120 for the ACAS shielding tape. The chart 300 shows the relative figures of merit for puncture resistance 330 to be 100 for the bronze shielding tape and 120 for the ACAS shielding tape. In summary, the chart 300, presents data that an ACAS shielding tape may be tougher, more resistant to breaking, and more puncture resistant than a bronze shielding tape.

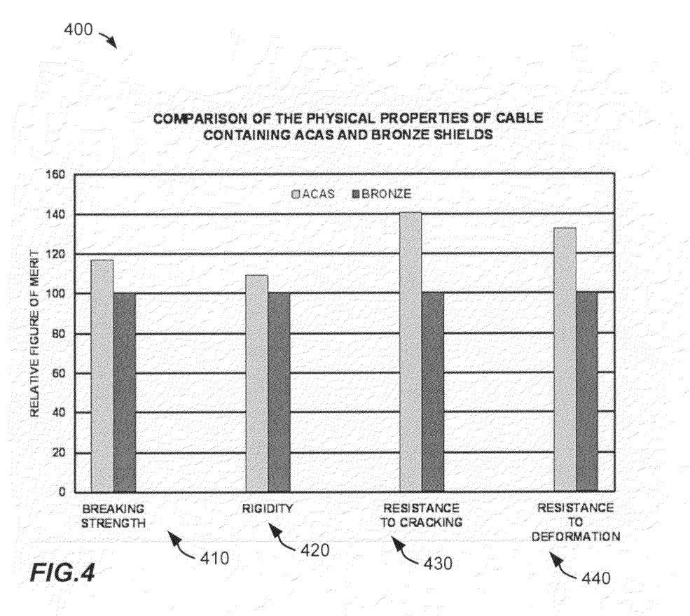

Turning now to FIG. 4, this figure is a chart 400 comparing physical properties of cables with asymmetric copper clad steel (ACAS) shields and cables with bronze shields according to one exemplary embodiment of the present invention. The chart 400 shows the relative figures of merit for breaking strength 410 to be about 100 for a cable with bronze shielding and about 115 for a cable with ACAS shielding. The chart 400 shows the relative figures of merit for rigidity 420 to be about 100 for a cable with bronze shielding and about 110 for a cable with ACAS shielding. The chart 400 shows the relative figures of merit for resistance to cracking 430 to be about 100 for a cable with bronze shielding and about 140 for a cable with ACAS shielding. The chart 400 shows the relative figures of merit for resistance to deformation 440 to be about 100 for a cable with bronze shielding and about 130 for a cable with ACAS shielding. In summary, the chart 400, presents data that a cable with ACAS shielding may have better breaking strength, higher rigidity, more resistance to cracking, and higher resistance to deformation than a cable with a bronze shielding tape. Since these are all beneficial attributes for handling, installation, and service longevity of cables, the ACAS cables may be considered to be more robust than bronze cables.

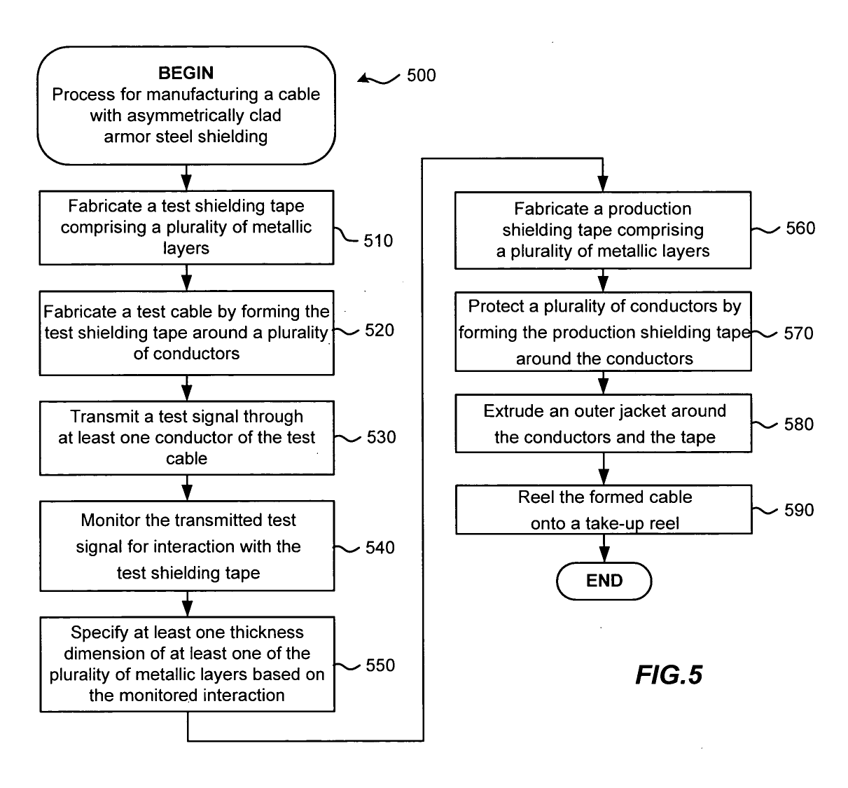

Turning now to FIG. 5, the figure shows a logical flow diagram 500 of a process for manufacturing a cable 200 with an asymmetrically clad alloy steel tape 100 according to one exemplary embodiment of the present invention. Certain steps in the processes or process flow described in all of the logic flow diagrams referred to below must naturally precede others for the invention to function as described. However, the invention is not limited to the order of the steps described if such order or sequence does not alter the functionality of the invention. That is, it is recognized that some steps may be performed before, after, or in parallel with other steps without departing from the scope or spirit of the invention.

In Step 510, a test shielding tape comprising multiple metallic layers can be fabricated. This tape can formed by plating, electroplating, depositing, soldering, welding, or otherwise affixing the layers of metal together or onto one another. The tape can also be formed by stacking the metals together and then rolling them into a single tape. The forming of the tape may also include steps of heating, melting, partially melting, annealing, trimming, or applying pressure. The test shielding tape can include a bimetallic tape comprising a steel alloy plated, or clad, by copper. The copper cladding may be symmetric or asymmetric. That is, one side of the tape may have a thicker layer of copper than the other layer of tape.

In Step 520, a test cable can be fabricated by wrapping the test shielding tape around a plurality of conductors. The test shielding tape can be the one from Step 510. Also, an outer cable jacket can be applied around the test shielding. The tape and jacket can be applied in substantially the same step or in separate steps. A jacketing or sheathing machine can be used. The outer jacket can be extruded.

In Step 530, a test signal can be transmitted through at least one conductor or pair of conductors within the test cable. This test cable is the one formed in Step 520. The test signal can span a range of frequencies for the intended operation of the cable. For example DC (direct current) up to 100 GHz or more. The test signal can have various waveforms such as square, random, triangular, chirped, sinusoidal, periodic, or continuous, for examples. The test signal can have various spectrums such as band limited, white, pink, Gaussian, base-band, pass-band, enveloped or random, for examples.

In Step 540, the test signal transmitted in Step 530 can be monitored for interaction with the test shielding tape. This interaction may imply performance characteristics of the test cable formed in Step 520. The interaction may be monitored by oscilloscope, BERT (bit error rate tester), network analyzer, cable tester, spectrum analyzer, cross-talk tester, capacitance meter, signal loss tester, signal attenuation tester or other electronic testing or monitoring equipment, for examples.

In Step 550, the thickness of at least one of the metallic layers of the test shielding (from Step 510) may be specified in response to any interactions between the test shielding and the test signal as monitored in Step 540. In this step, at least one thickness parameter of the shielding can be specified that may define a shielding that favors a desired performance characteristic of the cable. The thickness may be specified in mils thickness, microns thickness, or other units. The thickness may be specified as a percentage of total thickness or mass. The thickness may be specified as relative ratios of absolute thickness or percent thickness, or in any other absolute or relative form or measurement. The thickness may be specified in ranges.

In Step 560 a production shielding tape can be fabricated. The production shielding tape can have multiple metallic layers. One or more parameters of the production shielding tape may be specified by the thicknesses determined in Step 550. This tape can formed by plating, electroplating, depositing, soldering, welding, or otherwise affixing the layers of metal together or onto one another. The tape can also be formed by stacking the metals together and then rolling them into a single tape. The forming of the tape may also include steps of heating, melting, partially melting, annealing, trimming, applying pressure, applying electromagnetic radiation, or applying vibration. The tape manufactured can include a bimetallic tape comprising a steel alloy plated, or clad, by copper. The copper cladding may be symmetric or asymmetric. That is, one side of the tape may have a thicker layer of copper than the other layer of tape.

In Step 570, a plurality of conductors can be protected by wrapping the production shielding tape around the conductors. The wrapping can include placing an asymmetrically copper clad tape around the conductors so that the thicker layer of copper is closer to the conductors and the thinner layer of copper faces the outside of the cable. The wrapping can include forming the tape longitudinally around the conductors or also forming the tape helically around the conductors, for examples. The wrapping can be automated within a cable forming system or machine. The system may be known as a sheathing machine or a sheathing line comprising multiple machines. A filler structure, filling material, or water blocking material may be added among the conductors within the core of the cable.

In Step 580, an outer jacket can be extruded around the production shielding tape. Since the tape may be wrapped around the conductors, the outer jacket may be around both conductors and the production shielding tape. This extrusion of an outer jacket can be considered to form a completed shielded cable. The jacketing can be automated within a cable forming system or machine. The system may be known as a sheathing machine or a sheathing line comprising multiple machines.

In Step 590, the cable formed in Step 580 can be rolled up onto a take-up reel. The take-up of the cable can also be onto or into some other form provided to contain or support the fabricated cable. After the cable is formed and rolled up, it may be tested for conductivity, cross-talk, attenuation, shorts, bandwidth capacity, transfer function, transfer spectrum, shielding efficacy, other electrical properties, and/or any manner of physical properties. The process 500, while possibly run continuously, may be considered complete after Step 590.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. A method for making a communication cable, comprising the steps of:
disposing a metallic strip alongside a pair of insulated conductors;
forming the metallic strip around the pair of insulated conductors; and
extruding a jacket over the formed metallic strip and the pair of insulated conductors,
wherein the metallic strip comprises a layer of ferromagnetic material disposed between a first layer, comprising copper and having a first thickness, and a second layer, comprising copper and having a second thickness,
wherein the first layer faces the pair of insulated conductors and the second layer faces the extruded jacket, and
wherein the first thickness is substantially greater than the second thickness.

2. The method of claim 1, further comprising the step of specifying the first thickness to suppress electromagnetic coupling between the pair of insulated conductors and the layer of ferromagnetic material.

3. The method of claim 2, wherein the layer of ferromagnetic material has a third thickness, and wherein the method further comprises the step of specifying the third thickness to reduce copper content of the metallic strip as compared to a homogenous strip comprising copper.

4. The method of claim 3, further comprising the step of specifying the second thickness to protect the ferromagnetic material from corrosion.

5. The method of claim 4, wherein the step of specifying the second thickness further comprises specifying the second thickness to provide a path for at least some current associated with a lightning discharge.

6. The method of claim 1, wherein the layer of ferromagnetic material has a third thickness, and
wherein the method further comprises refining the first thickness, the second thickness, and the third thickness to meet a copper content objective, a conductivity objective, a mechanical strength objective, a corrosion objective, and a signal attenuation objective.

7. The method of claim 1, wherein the layer of ferromagnetic material has a third thickness, and wherein the first thickness, the second thickness, and the third thickness have been refined to reduce copper content of the metallic strip while achieving at least one signal performance objective.

8. A method for manufacturing a communication cable, comprising the steps of:
fabricating a test cable in response to forming a test shielding tape, comprising a plurality of metallic layers, around a plurality of conductors;
transmitting a test signal through at least one conductor in the plurality of conductors of the test cable;
monitoring the transmitted test signal for interaction with the test shielding tape;
specifying at least one thickness dimension of at least one of the plurality of metallic layers based on the monitored interaction; and
producing the communication cable in response to forming a production shielding tape, comprising a plurality of metallic layers and conforming to the specified at least one thickness dimension, around at least one pair of insulated conductors.

9. The method of claim 8, wherein the plurality of metallic layers of the production shielding tape comprises:
a first metallic layer, comprising copper, facing the at least one pair of insulated conductors,
a second metallic layer, comprising copper, facing outward with respect to the at least one pair of insulated conductors, and
a third metallic layer, comprising iron, between the first metallic layer and the second metallic layer.

10. The method of claim 9, wherein the at least one specified thickness dimension comprises a thickness of the first metallic layer that is sufficient to control electromagnetic coupling between the at least one pair of insulated conductors and the iron.

11. The method of claim 10, wherein the at least one specified thickness dimension further comprises a second thickness of the second metallic layer that is sufficient to provide a path for conducting at least a portion of a lightning strike longitudinally along the shielding tape.

12. The method of claim 11, wherein the second thickness of the second metallic layer is further sufficient to suppress corrosion of the iron.

13. The method of claim 12, wherein the at least one specified thickness dimension further comprises a third thickness of the third metallic layer that reduces copper content of the cable while meeting a signal attenuation specification.

14. The method of claim 8, wherein specifying the at least one thickness dimension comprises:
specifying a first thickness of a first layer, comprising steel and disposed between a second layer and a third layer, to manage copper content of the production shielding tape;
specifying a second thickness of the second layer, to suppress coupling between the at least one pair of insulated conductors and the steel; and
specifying a thickness of a third layer to protect the steel from oxidation, and
wherein forming the production shielding tape around the at least one pair of insulated conductors comprises disposing the second layer between the first layer and the at least one pair of insulated conductors.

15. A method for protecting a conductor, comprising the steps of:
feeding the conductor and a tape into a sheathing machine; and
forming the tape over the conductor as the tape and the conductor feed through the sheathing machine,
wherein the tape comprises a first layer, of a first material that comprises iron, laminated between a second layer and a third layer of a second material that comprises copper, and
wherein the second layer is substantially thicker than the third layer.

16. The method of claim 15, wherein the tape further comprises a first edge and a second edge that each extends lengthwise along the tape, and
wherein forming the tape over the conductor comprises:
positioning the second layer of the tape towards the conductor; and
overlapping the first edge over the second edge, with the first and second edges extending essentially parallel to the conductor.

17. The method of claim 15, wherein the tape further comprises a first edge and a second edge that each extends longitudinally along the tape,
wherein forming the tape over the conductor comprises disposing the first edge adjacent the conductor and disposing the second edge over the first edge, and
wherein the first material is ferromagnetic.

18. The method of claim 15, wherein the feeding step comprises synchronously feeding the conductor and the tape into the sheathing machine from respective feed reels, and
wherein the method further comprises the steps of:
forming cable in response to the sheathing machine extruding jacket material over the tape and the conductor; and
reeling the formed cable onto a take-up reel at a downstream end of the sheathing machine.

19. The method of claim 15, wherein the second layer faces the conductor and suppresses electromagnetic coupling between the conductor and the first layer.

20. The method of claim 19, wherein suppressing electromagnetic coupling comprises achieving an attenuation specification for a signal transmitting on the conductor.
